(19) United States
(12) Patent Application Publication
(10) Pub. No.: US 2013/0104401 A1
(43) Pub. Date: May 2, 2013

(54) Anatomically configured razor device

(71) Applicant: Milly Rodriguez, Rego Park, NY (US)

(72) Inventor: Milly Rodriguez, Rego Park, NY (US)

(21) Appl. No.: 13/373,013

(22) Filed: Nov. 2, 2011

(51) Int. Cl. B26B 19/14

(52) U.S. Cl. 30/42

(57) ABSTRACT

A razor device is configured to shave anatomical regions including the pubic area, the inner buttocks and under the arms of a person's body. The razor device is an electric shaver and includes a razor head containing at least one rotating razor blade which is connected to a handle. The motor and the batteries would preferably be housed in the handle and electrical connections such as wiring would run from the handle to the razor head. The shaver makes it possible to shave unwanted hair form genital regions of a person's anatomy that are not readily accessible with a conventional razor device. The shaver includes a compact slim handle with two separate interchangeable razor heads that are removably connected to the handle at an angle. In another embodiment instead of a single razor head, the razor head would include two rotational razor blades mounted one atop of the other.

### BACKGROUND

### Field

The present invention relates to a razor that is adapted to anatomically shave certain regions of a user's body. In particular the present invention is related to a razor adapted to shave a person's inner buttocks, pubic or bikini area or the underarms of a user close and safely. The present invention is preferably intended to provide an electric razor with interchangeable razor heads each configured to accommodate various anatomical regions for shaving of a user's body.

### The Related Prior Art

It is desirable for many to shave unwanted pubic hair from genital regions of one's anatomy that are not safe to shave with standard razors. It therefore would be desirable to provide a razor that can safely remove hair from certain regions on a person's anatomy such as near the genital regions or between the cheeks of the buttocks without the risk of cutting the skin in those regions.

U.S. Pat. No. 5,208,982 relates to a razor device for shaving concave areas. The blade is standard flat edge razor blade.

U.S. Pat. No. 6,530,151 discloses another straight edge razor blade shaving device.

It would be desirable to provide an electric shaving device that is easy to control has pinpoint accuracy for the shaving area for sensitive areas to be shaved and minimizes the risk of injury to those areas. Actual cutting area on the typical shaver head is relatively too big as well as the handle being useable to reach genital regions and gluteal cleft area in a safe and efficient way. There is definitely a great need to provide a shaving system that addresses these disadvantages.

### SUMMARY

The present invention provides a razor that is configured to shave in these regions that can include the pubic area, the inner buttocks and the under the arms of a person's body. The present invention is configured as a razor having a razor head containing at least one rotating razor blade which is connected to a handle in similar fashion as is an electric toothbrush. The motor and the batteries would preferably be housed in the handle and electrical connections such as wiring would run from the handle to the razor head. In another embodiment instead of a single razor head the razor head would include two rotational razor blades mounted on top of the other preferably in vertical alignment.

The present invention provides for a shaver that preferably has a compact slim handle with preferably two separate interchangeable elongated razor heads each of which can be angularly connected to the handle. The angle of connection is greater than 90 degrees but less than 180 and preferably 135 degrees to provide for better shaving coordination by a user. This innovative and slim unique design of the present invention makes it easy to move the shaver in particularly narrow areas of the body in different directions to navigate the curves of the body virtually shaving every hair by contouring the shaving head appropriately or by providing slight pressure against the skin within the shaving head to achieve a clean and precise shave in hard to reach delicate areas without cutting the skin. It therefore would be desirable to provide a razor that can safely remove hair from certain regions on a person's anatomy with a slim design to easily reach these regions such as mons pubis, groin, labia majora, scrotum and gluteal cleft without the risk of nicks or cuts of the skin. The present invention provides a razor device that will give a user an incredibly close shave with less skin irritation with a comfortable feeling when shaving that is extra smooth, easy and safe to use. The present invention is great for personal use at home, a great tool for physicians in medical facilities before surgical procedures or for technicians before hair removal treatments.

The present invention further provides for razor heads that are intended for a large number of uses and that can be manufactured inexpensive and sold separately from the handle. In addition the razor heads of the present invention are intended for disposable use and can be inexpensively sold separately from the handle for use by medical facilities. Further, the handle of the present invention may be rechargeable and the present invention can include a compact rechargeable stand. The present invention provides a shaver that is intended for either wet or dry use.

### BRIEF DESCRIPTION OF THE DRAWINGS

FIGS. 1A, 1B and 1C show a first embodiment of the present invention of a razor that is interchangeable by detachably connecting to the handle (FIG. 1A) a single head razor (FIG. 1B) to a double headed razor (FIG. 1C);

FIG. 2 shows the first embodiment of FIGS. 1A and 1B connected to each other;

FIG. 3 shows the first embodiment of FIGS. 1A and 1B connected to each other in which a battery indicator and an on/off switch is shown;

FIG. 4 shows the first embodiment of FIGS. 1A and 1B connected to each other in which a battery indicator and an on/off switch is shown; and

FIG. 5 is another embodiment of the present invention in which a second razor FIG. 2 shows the on/off switch.

### DESCRIPTION OF THE PREFERRED EMBODIMENTS

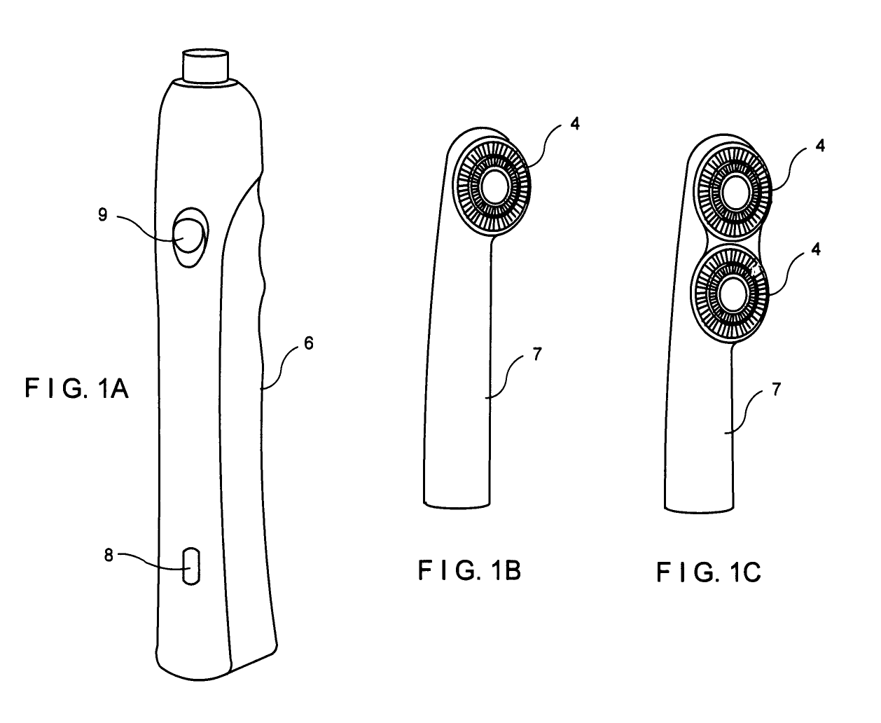

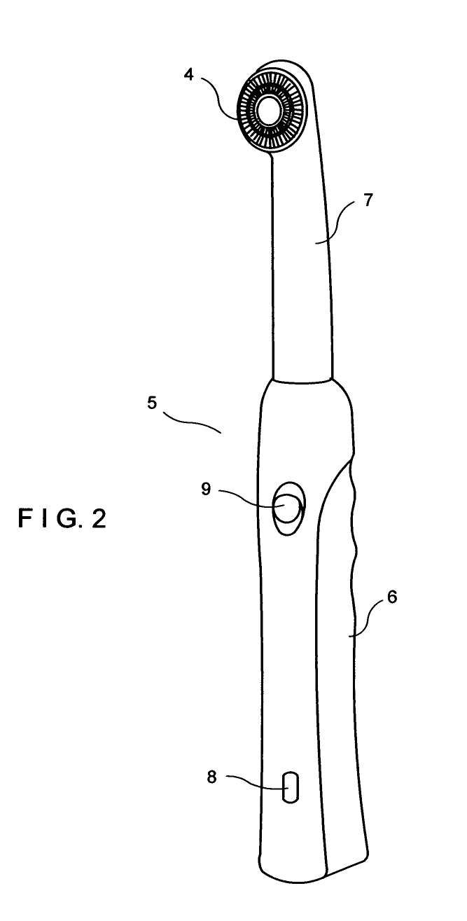

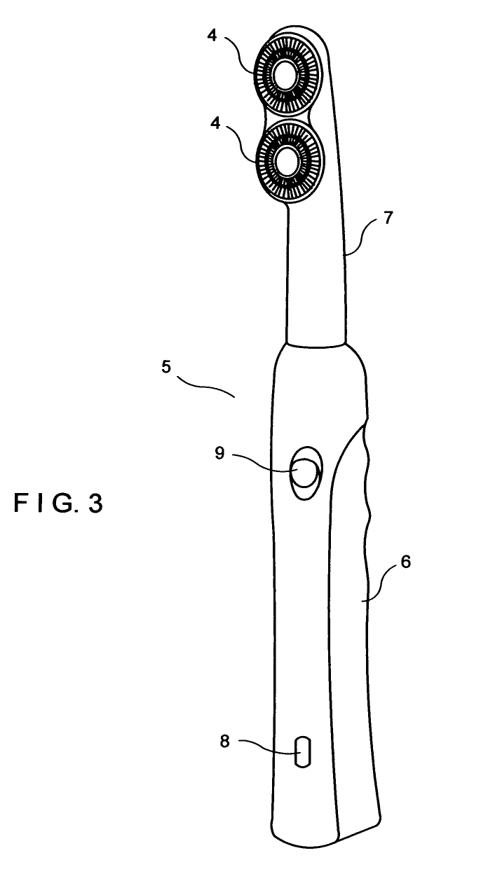

Referring now to the drawings FIG. 1 shows a first embodiment of the invention in which an electrically rotating razor blade device 5 is provided that is adapted to shave certain anatomical areas of the body, namely the pubic region, the underarms and between the buttocks to remove unwanted hair for grooming purposes with specific precisions and safely. The razor device 5 includes a handle 6 and a razor head 7. The device has a compact slim handle with two separate interchangeable slightly angled razor heads. The razor head in the embodiment of FIG. 1B has a single razor that is preferably a rotating blade 4. The configuration of the razor device resembles that of an electric tooth brush. It is compact, easy to hold and manipulates itself readily for shaving in the aforementioned sensitive areas of the human body while at the same time minimizing the risk of injury in the areas to be shaved due to cuts because of the ease of control of the device and the small controllable razor head. The device 5 is configured as handle 6 having mounted on one distal end thereof a razor head 7 that is small preferably in one embodiment including a single rotary razor with its rotating razor head 7 facing upward from the base of the handle end that it is mounted upon. In the embodiment of FIG. 1C instead of one razor head there are two heads 7 preferably mounted one on top of the other e.g. vertically aligned with respect to the handle's longitudinal axis to provide a larger shaving area on a user's body. The head 7 is compact and is configured to be specific to the area to be shaved to provide for removal of hair where desired by the user of the device 5. The head 7 and the handle 6 are configured to snap together with each other or to be otherwise connected at an angle of between 90 degrees and 180 degrees and preferably no greater than 135 degrees with respect to each other. The device 5 provides great control by the person who is shaving with the device 5. The device 5 is preferably battery operated and can preferably include a battery indicator 8 as shown in FIGS. 2 and 3 and has a preferably sliding on/off switch 9 to turn the rotating razor blade head 7 on or off accordingly such as is done with an electric tooth brush. The motor and the batteries are preferably located in the handle 6 of the device 5 and wires can run from within the handle 5 to the razor head 7 or heads 7 (see FIGS. 1B and 1C) within the device when the switch 9 is on. It is understood that the present invention is not limited to the widths shown in these drawings for the razor head portion 7 and the handle 6 and that the razor head portion 7 can be configured to have a thinner width than that of the width of the handle 6 such as for in the case of an electric toothbrush. The handle 6 can be slightly curved shaped to provide for ease in shaving by user, preferably no greater than 15 degrees or alternatively can be straight. The handles 6 can also be removably mounted to the razor head 7.

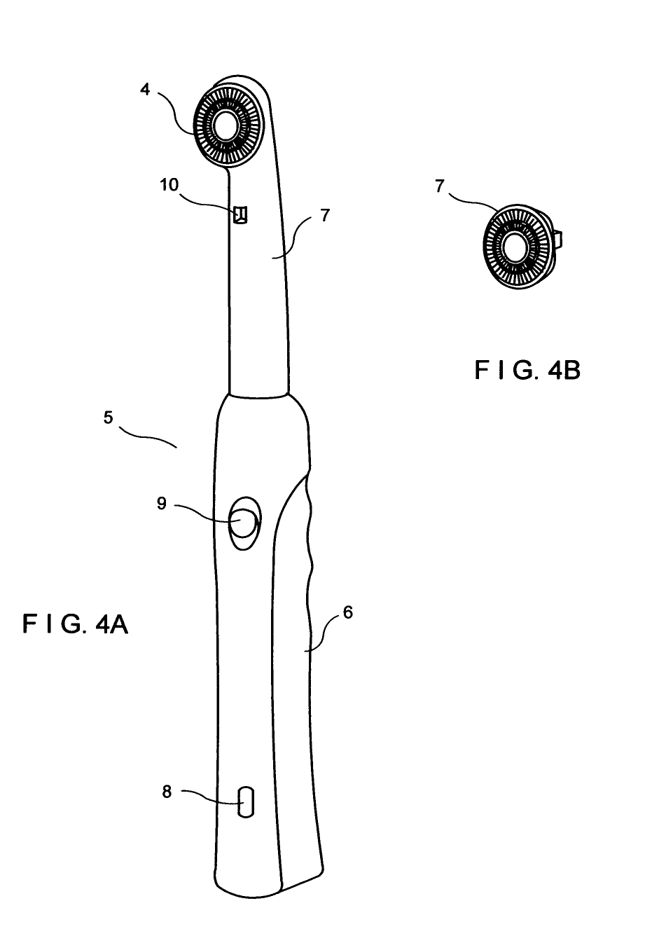

FIGS. 4A and 4B show another embodiment of a head having the capability of mounting a second additional razor on the razor head 7 which may be preferable for users having considerably more hair to shave in the aforementioned regions. The razor head 7 has a connecting component 10 for a second rotating razor to be mounted thereon preferably by snapping it onto the component which can be a peg or other known component in the art. The heads again are preferably mounted one atop the other to provide for a greater hair removal area for a user who may require it for certain areas of the user's body. This device in terms of the battery indicator 8 and the on/off switch 9 (FIG. 4A) and the motor housing and the wires running from within the handle to the heads is the same or similar to that previously described for the single rotating head embodiment of FIG. 1B. Non-limiting illustrative examples of similar wiring for the motor in handle to the razor head can be found in U.S. Pat. Nos. 6,721,986 and 7,266,855 which are incorporated herein by reference thereto.

Additional features of the present invention include that the razor heads 7 that are intended for a large number of uses and that they can be manufactured inexpensively and sold separately from the handle 6. The razor heads 7 of the present invention are intended for disposable use and can be inexpensively sold separately from the handle 6 for use by medical facilities. Further, the battery or batteries housed in the handle 6 of the present invention may be rechargeable and the present invention can include a compact rechargeable stand for recharging the battery or batteries in the handle 6. The present invention provides a shaver device 5 that is intended for either wet or dry use when shaving.

While presently preferred embodiments have been described for purposes of the disclosure, numerous changes in the arrangement of method steps and those skilled in the art can make apparatus parts. Such changes are encompassed within the spirit of the invention as defined by the appended claims.

What is claimed:

1. A razor device configured to shave anatomical regions that includes the pubic area, the inner buttocks and under the arms of a person's body, comprising:
a razor device including a razor head and a handle, said razor head including at least one rotating razor blade, said razor head being adapted to be connected to said handle for the razor device;
a motor and one or more batteries housed in said handle and electrical connections from within said handle to the razor head.

2. The razor device according to claim 1 wherein said razor has one rotating razor blade.

3. The razor device according to claim 1 wherein said razor head has two razor blades mounted one on top of the other to facilitate the removable of unwanted hair by a user.

4. The razor device according to claim 1 wherein said razor device includes a battery indicator indicating if the batteries need a charge or are running low.

5. The razor device according to claim 1 wherein said handle includes a switch mounted thereon to turn said device on or off.

6. The razor device according to claim 5 wherein said switch is a slidable switch mounted on a surface of said handle.

7. The razor device according to claim 6 wherein said handle is dismountable and includes an exchangeable razor head.

8. The razor device according to claim 6 wherein said razor handle and said razor head are connected to each other at an angularly to better facilitate shaving pubic areas of a user safely.

9. The razor device according to claim 8 wherein said angular connection is 135 degrees between the handle and the razor head.

10. The razor device according to claim 1 wherein said razor head includes a connection component adapted to receive a second rotating razor thereon.

11. The razor device according to claim 1 wherein said handle is slightly curved to provide for better gripping by a user.

12. The razor device according to claim 8 wherein said handle has a slight curvature of not greater than 15 degrees.

13. The razor device according to claim 1 wherein said razor heads are disposable razor heads that can be used multiple times and disposed separate from said handle.

14. The razor device according to claim 1 wherein said handle has one or more batteries therein that are rechargeable.

15. The razor device according to claim 14 wherein said device includes a compact rechargeable stand for recharging said one or more batteries in said handle.

16. The razor device according to claim 1 wherein said device can be used for either wet or dry use in shaving.
